(19) United States
(12) Patent Application Publication
(10) Pub. No.: US 2026/0176408 A1
(43) Pub. Date: Jun. 25, 2026

(54) VALUE CHAIN RETURN PROCESS FOR THE RECOVERY OF NOT BONDED ADDITIVES BY EXTRACTION FROM POLYURETHANE OR POLYISOCYANURATE RIGID FOAMS AND DEPOLYMERIZATION OF THE POLYURETHANE RIGID FOAMS

(71) Applicant: BASF SE, Ludwigshafen am Rhein (DE)

(72) Inventors: Thomas SCHAUB, Ludwigshafen am Rhein (DE); Daniel TELKEMEYER, Lemfoerde (DE); Torsten MATTKE, Ludwigshafen am Rhein (DE); Markus SCHUETTE, Lemfoerde (DE); A. Stephen K. HASHMI, Heidelberg (DE); Philippe KLEIN, Heidelberg (DE)

(73) Assignee: BASF SE, Ludwigshafen am Rhein (DE)

(21) Appl. No.: 19/126,813

(22) PCT Filed: Nov. 2, 2023
(86) PCT No.: PCT/EP2023/080535

§ 371 Date: May 2, 2025

(30) Foreign Application Priority Data
Nov. 3, 2022 (EP) 22205386.0

(51) Int. Cl. C08G 18/40; C08G 18/10; C08G 18/32; C08G 18/48; C08G 18/76

(52) U.S. Cl. CPC C08G 18/4072; C08G 18/10; C08G 18/3206; C08G 18/4829; C08G 18/4833; C08G 18/7664

(57) ABSTRACT

The present invention is directed to a value chain return process for polyurethane and polyisocyanurate rigid foams containing at least one additive (A1) which is not chemically bonded to the polymer chain selected from the group consisting of phosphorous ester-based flame retardants, polymerization catalysts and surfactants comprising the steps of providing a composition comprising a comminuted polyurethane or polyisocyanurate rigid foam, wherein the comminuted foam has a content of intact cells of less than 10%, based on the number of intact cells of the not comminuted polyurethane or polyisocyanurate rigid foam, and extraction of the additive (A1) with a solvent at a temperature below 190° C.

The present invention relates to a value chain return process for polyurethane rigid foams which allows for the recovery of phosphorous ester-based flame retardants and other additives contained therein which are not bonded in the polymer chain by extraction.

In particular, the present invention is directed to a value chain return process for polyurethane and polyisocyanurate rigid foams containing at least one additive (A1) which is not chemically bonded to the polymer chain selected from the group consisting of phosphorous ester-based flame retardants, polymerization catalysts and surfactants comprising the steps of providing a composition comprising a comminuted polyurethane or polyisocyanurate rigid foam, wherein the comminuted foam has a content of intact cells of less than 10%, based on the number of intact cells of the not comminuted polyurethane or polyisocyanurate rigid foam, and extraction of the additive (A1) with a solvent at a temperature below 190° C.

The present invention is also directed to a phosphorous ester-based flame retardant obtained or obtainable according to said process as well as the use thereof for the preparation of polyurethanes or polyisocyanurates. Furthermore, the present invention is also directed to polymerization catalysts obtained or obtainable according to said process and surfactants obtained or obtainable according to said process as well as the use thereof for the preparation of polyurethanes or polyisocyanurates.

In the last three decades, there has been an enormous increase in worldwide plastics demand. For example, in the last 10 years, the amount of plastics produced worldwide has increased by almost 50%. Within 30 years, it has even almost quadrupled reaching an amount of 359 million metric tons in 2018. From these facts, it becomes clear that production of said huge amounts of plastics is followed by a need to dispose or recycle spent plastics. Preference should be given to recycling as thereby valuable materials, e.g. compounds which can act as monomers, can be added back to the value chain, e.g. by direct re-use in plastics production. Plastics are used with additive components incorporated for the purpose of imparting various functions to the resins. For example, as resins have high combustibility by themselves, the resins are mixed with flame retardants in a proportion of up to 25% by weight from the viewpoint of preventing the spread of fire. The possibility of returning flame retardants into the industrial cycle appears to be promising both with respect to saving of resources and from an economic point of view.

In addition, in the industrial production of polyurethane rigid foams, polyurethane (PU) rigid foam wastes are incurred. For example, such waste of PU rigid foam is obtained upon casting blocks of PU rigid foam, followed by cutting, trimming or sizing said blocks to obtain the desired PU workpiece. Additionally, rejects of PU rigid foams such as off-spec products are incurred.

Thus, there is a need to develop processing techniques to recover materials from plastic waste. The recycling process should reduce both the waste of material and the carbon footprint. Further, it should be an economical and energy efficient process delivering valuable materials which comprise high technical features. In contrast, disposal, e.g. by combustion, has a negative impact on the environment as well as on the carbon footprint.

Among the plastics mentioned above, polyurethanes (PU) are important representatives. Generally, polyurethanes are produced by polyaddition of (poly) isocyanates with polyol. The characteristic chain link is the urethane group. Polyurethane exists in many types, e.g. as foams, elastomers, or thermosets, among which foams are especially important.

The polyaddition of (poly) isocyanates with polyol results in the formation of linear, branched, or cross-linked polyurethanes. As an alternative to alcohols, the most important group of NCO-reactive compounds are amines resulting in the formation of di- or trisubstituted ureas. Ureas are also formed by the reaction of water with isocyanates, in which the carbamic acid formed in the first step of the reaction spontaneously decomposes to an amine with elimination of carbon dioxide. This amine then reacts with excess isocyanate to yield symmetrically substituted ureas. This reaction is the basic reaction leading to polyurethane foams, if not external foaming agents as low boiling hydrocarbons are used.

These foams may be formed in wide range of densities and may be of flexible, or rigid foam structures. Generally speaking, “flexible foams” are those that recover their shape after deformation. In addition to being reversibly deformable, flexible foams tend to have limited resistance to applied load and tend to have mostly open cells. “Rigid foams” are those that generally retain the deformed shape without significant recovery after deformation. Rigid foams tend to have mostly closed cells. Whether PU flexible foams or PU rigid foams are formed during polyaddition mainly depends on the types of polyisocyanate and polyol components used. For example, the starting materials may influence the crosslinking of the polymers meaning that the polymer consists of a three-dimensional network. Long, flexible segments, contributed by the polyol, result in the formation of PU flexible foams. PU rigid foams are obtained from short chains with many crosslinks. More details for the polyurethane rigid foams suitable to be used according the invention can be found in Polyurethane Handbook 2nd edition, 1993, chapter 6.

Polyurethane rigid foams provide excellent insulation properties. Thus, they are of great importance in the construction sector and commonly used as insulation materials, e.g. for buildings insulations. However, for application of polyurethane rigid foams as insulation material in buildings, the addition of flame retardants is necessary for fire protection reasons. For this purpose, flame retardants are added in the production process of the polyurethane rigid foams. Nowadays, mainly phosphorous esters, such as tris(2-chloroethyl)phosphate, tris(chloroisopropyl)phosphate, tris(1,3-dichloro-2-propyl)phosphate, tris(2-ethylhexyl)phosphate, triethylphosphate, tricresylphosphate, tris-(2,3-dibromo)phosphate, tetrakis-(2-chlorethyl)-ethylenediphosphate, dimethylphosphonate, dimethylpropylphosphonate, diphenylcresylphosphate, and mixtures thereof are used as flame retardants in polyurethane rigid foams for constructions applications (see: Chemosphere, 2012, 88, 1119-1153 and WO 2015/121057). These flame retardants are not chemically bonded to the polymer chains of the polyurethanes.

Besides these flame retardants to a minor extend other valuable additives from the polymer synthesis are also present and not chemically bonded to the polymer chains of the polyurethane such as for example the polymerization catalysts as well as surfactants. A recovery of these additives together with the flame retardants and reuse of them for the synthesis of new polyurethane rigid foams would also be desirable.

The recycling of polyurethane rigid foams to valuable monomeric compounds and recovery of the phosphorous ester flame retardants as well as other additives still remains challenging. The polyol compound and amine can be recovered and recycled by glycolysis or hydrolysis (see: Plastics recycling and Polyurethanes, in Ullmann's Encyclopedia of Industrial Chemistry, 2020, DOI: 10.1002/14356007.a21_057.pub2) but also by hydrogenation in the presence of a hydrogenation catalyst (see: ChemSusChem, 2020, DOI: 10.1002/cssc.20200246 or ChemSusChem, 2021, DOI: 10.1002/cssc.202101705)

U.S. Pat. No. 4,196,148A describes a method for hydrolysis of polyurethane foam and recovery of diamines and polyethers (or polyesters) from the hydrolysate carried out near atmospheric pressure and temperatures above 185° C. No recovery of a flame retardant is presented in this work.

While hydrolysis of polyurethane foams allows for recycling of the constituting monomers, phosphorous-based flame retardants are being decomposed under the harsh hydrolytic reaction conditions (see: Ullmann's Encyclopedia of Industrial Chemistry, Phosphorus Compounds, Organic, 2012, DOI: 10.1002/14356007.a19_545.pub2). Such decomposition is not only disadvantageous from the perspective that the flame retardants are no longer available for reuse, but the hydrolysis products of the esters can also contaminate the polyol and/or the polyamine which may result in a more complicated, resource-intensive and expensive work-up process.

Therefore, it would be of high economic interest to recycle and depolymerize polyurethane rigid foams in a way that the polyol, the polyamine as well as the phosphorous ester-based flame retardant can be obtained.

T. Skrydstrup et al., JACS Au, 2021, DOI: 10.1021/jacsau.1c00050 describe the depolymerization of polyurethanes using 2 mol-% of a homogeneous iridium catalyst with tridentate P,N,P-ligands in 2-propanol as solvent at 150° C. and 30 bar H₂ pressure. In this work, methylenedi (phenylisocyanate)-based polyurethane rigid foams from a refrigerator insulation were hydrogenated yielding the corresponding diamine as well as the polyol. The authors detected a phosphorous compound in the polyol fraction having a signal at 20.00 ppm in the ³¹P NMR spectrum. It was suggested that this phosphorous compound may be due to a phosphorous-based flame retardant, but no further confirmation, characterization or isolation of this unknown phosphorous compound was carried out. However, PU rigid foams used in refrigerator insulations usually do not contain phosphorus-based flame retardants. Also, commonly used phosphorous ester-based flame retardants for polyurethane rigid foams do not have a chemical shift of around 20 ppm in the ³¹P NMR spectrum, but usually below 1 ppm: −2.5 ppm for tris(2-chloroethyl)phosphate (see: Zhurnal Obshchei Khimii, 1978, 78, 694-695), −4.2 ppm for tris(chloroisopropyl)phosphate (measured at a reference sample), 0.24 ppm for tris(2-ethylhexyl)phosphate (see: J. Chem. Eng. Data, 2008, 53, 2718-2720) or −0.8 ppm for triethylphosphate (see: Phosphorus, Sulfur and Silicon and the Related Elements, 1991, 61, 31-39). Therefore, Skrydstrup et al. does not disclose the recovery of a phosphorous ester-based flame retardant from a polyurethane rigid foam. Most likely, the authors detected in the ³¹P NMR spectrum the phosphine oxide of the phosphine-ligand of the catalyst that was employed. The oxide of said PNP-ligand, Ph₂P(O)C₂H₄NHC₂H₄P(O)Ph₂, has a phosphine oxide signal at 20 ppm in the ³¹P NMR spectrum (measured at a reference sample of the oxidized PNP-ligand).

T. Schaub et al., ChemSusChem, 2021, DOI: 10.1002/cssc.202101606 describe the depolymerization of polyurethanes using 2-4 mol-% of a homogeneous manganese catalyst with tridentate P,N,N-ligands in toluene or THF as solvent at 130 to 200° C. and 60 bar H₂ pressure. When applying the system to methylenedi (phenylisocyanate)-based polyurethane rigid foams, the corresponding diamine as well as the polyol could be obtained and isolated. Said rigid foams did not contain a phosphorous-based flame retardant.

T. Skrydstrup et al., ChemSusChem, 2021, DOI: 10.1002/cssc.202101705 describe the depolymerization of polyurethanes using 1 mol-% of a homogeneous manganese catalyst with tridentate P,N,P-ligands in 2-propanol as solvent at 180° C. and 50 bar H₂ pressure. This system was applied to a methylenedi (phenylisocyanate)-based polyurethane rigid foam from a refrigerator insulation and a polyurethane rigid foam for decoration. In both cases, the corresponding diamine as well as the polyol could be obtained and isolated. The authors detected a phosphorous compound in the polyol fraction obtained from the PU rigid foam for decoration having a signal at 31.00 ppm and a phosphorous compound in the polyol fraction obtained from the PU rigid foam from a refrigerator insulation having a signal at 32.05 ppm in the ³¹P NMR spectrum. As described above, also for these unknown phosphorous compounds, the authors suggested that the signal may originate from a phosphorous-based flame retardant. Again, no further confirmation, characterization or isolation of the unknown phosphorous compounds was carried out. However, as described above in further detail, PU rigid foams used in refrigerator insulations and decoration usually do not contain phosphorus-based flame retardants. Also, commonly used phosphorous ester-based flame retardants for polyurethane rigid foams do not have a chemical shift of around 31 ppm in the ³¹P NMR spectrum, but usually below 1 ppm (see above). Therefore, also this work does not disclose the recovery of a phosphorous ester-based flame retardant from a polyurethane rigid foam.

The above-described plastics recycling processes do so far not disclose a method for recycling polyurethane rigid foams in way to obtain both the valuable amine components and the polyol components alongside with recovering the phosphorous ester-based flame retardants.

Therefore, it was an object of the present invention to depolymerize polyurethane rigid foams containing additives that are not chemically bonded to the polymer chain such as flame retardants, stabilizers or catalysts, in particular phosphorous ester-based flame retardants, in a way that the polyol, the aromatic amine as well as the phosphorous ester-based flame retardant and other additives can be obtained and preferably also be reused.

This object has been achieved by a value chain return process for polyurethane rigid foams containing at least one additive (A1) which is not chemically bonded to the polymer chain selected from the group consisting of phosphorous ester-based flame retardants, polymerization catalysts and surfactants, in particular at least one phosphorous ester-based flame retardant by extraction. The process comprises extracting the phosphorous ester-based flame retardant and other not bonded additives with a solvent, in particular an organic aprotic solvent, at a temperature below 190° C. and recovery of them followed preferably by a depolymerization of the remaining polyurethane rigid foam after the extraction to the polyol as well as the amine component and separation of the amine as well as the polyol component.

The present invention is directed to a value chain return process for polyurethane and polyisocyanurate rigid foams containing at least one additive (A1) which is not chemically bonded to the polymer chain selected from the group consisting of phosphorous ester-based flame retardants, polymerization catalysts and surfactants comprising the steps of
a) providing a composition comprising a comminuted polyurethane or polyisocyanurate rigid foam, wherein the comminuted foam has a content of intact cells of less than 10% based on the number of intact cells of the not comminuted polyurethane or polyisocyanurate rigid foam,
b) extraction of the additive (A1) with a solvent at a temperature below 190° C.

“Value chain return” is intended to mean that the low molecular products obtained by the process of the invention can be re-integrated in a value chain leading to polyurethanes or else be used as feedstocks in an other value chain.

In the context of the present invention, a “comminuted thermoplastic polyurethane or polyisocyanurate rigid foam” means the material is obtained from a rigid foam and the comminuted thermoplastic polyurethane or polyisocyanurate is for example used in shredded form, in the form of granules, as an agglomerate, or as a powder. The polyurethane or polyisocyanurate rigid foams can be comminuted by conventional methods, for example by shredding, e.g. in a rotation mill or rotary mill at room temperature, to a particle size of ordinarily less than 20 mm, or ground, e.g. by known cold grinding processes. Preferably, a particle size of less than 5 mm is selected, for example a particle size in the range of 0.01 mm to 5 mm, and preferably in the range of 0.01 mm to 1 mm.

The process of the present invention comprises steps a) and b) and may comprise further steps. According to step a), a composition comprising a comminuted polyurethane or polyisocyanurate rigid foam, wherein the comminuted foam has a content of intact cells of less than 10%, based on the number of intact cells of the not comminuted polyurethane or polyisocyanurate rigid foam, is provided. Suitable methods for preparing a composition comprising a comminuted polyurethane or polyisocyanurate rigid foams are in principle known from the state of the art. “Intact cells” in the context of the present invention means that the cell structure and the shape of the cells is similar, preferably identical, to the cell structure and the shape of the cells of the not comminuted foam. According to the present invention, the cell structure of the comminuted rigid foam is preferably destroyed and the material provided has a content of closed cells of less than 10%, preferably of less than 5%, in particular of less than 2%, more preferably of less than 1%, particularly preferable less than 0.5%, in each case based on the number of intact cells of the not comminuted polyurethane or polyisocyanurate rigid foam. The composition might contain further components, for example solvents.

Unless otherwise noted, in the context of the present invention the content of intact cells is determined by light microscopy of samples of the materials and comparison of the cell count of the respective samples of not comminuted foam and the comminuted foam.

According to step b), the additive (A1) is extracted with a solvent at a temperature below 190° C. It is also possible to extract two or more additives in the extraction step according to the present invention. Usually, at least 20% of the additive (A1) present in the polyurethane or polyisocyanurate rigid foam are extracted in step b), preferably at least 30%, more preferable at least 40%, in particular at least 50%. Preferably, 50% to 100% of at least one additive (A1) are extracted in step b), in particular 80% to 99.9%, more preferable 90% to 99%.

According to the present invention, the process may also comprise two or more extraction steps using different solvents and/or different temperature ranges.

According to step b), the solvent comprising additive (A1) is obtained as well as the remaining comminuted polyurethane or polyisocyanurate.

Preferably, the polyurethane or polyisocyanurate rigid foam obtained in step b) is subjected to further steps according to the present invention, in particular a depolymerization step.

According to a further embodiment, the present invention is also directed to the process as disclosed above, wherein the process further comprises step c)
c) depolymerization of the comminuted polyurethane or polyisocyanurate obtained in step b).

The extraction step and a depolymerization of the comminuted polyurethane rigid foam may also be combined according to the present invention. It may be possible that during step b, also depolymerization or partial depolarization occur. Preferably, the extraction step and the depolymerization step are separate steps according to the present invention.

Suitable methods for depolymerization are in principle known to the person skilled in the art. Preferably, the depolymerization is achieved by hydrolysis, glycolysis, hydrogenation or by aminolysis according to the present invention. Preferably, depolymerization is achieved by glycolysis or hydrolysis according to the present invention.

Depending on the method used for depolymerization, different products are obtained. Typically, the isocyanate component is obtained and can be separated but also the polyol component may be separated, in particular in case depolymerization is achieved by glycolysis. The process of the present invention may also comprise further separation steps.

According to a further embodiment, the present invention is also directed to the process as disclosed above, wherein the depolymerization according to step c) is carried out by a method selected from hydrolysis, glycolysis, hydrogenation or by aminolysis.

Surprisingly, in the value chain return process according to the present invention, the additive (A1) which is not chemically bonded to the polymer chain selected from the group consisting of phosphorous ester-based flame retardants, polymerization catalysts and surfactants, in particular the phosphorous ester-based flame retardants are recovered in a chemically unchanged form when extracting from the spend rigid polyurethane foam by extraction with a suitable solvent, in particular an aprotic organic solvent below 190° C. Surprisingly, using these conditions, the polymerization catalysts, surfactants and phosphorous ester-based flame retardands are not being decomposed under the extraction conditions applied in the process. This allows for the additives, in particular the phosphorous ester-based flame retardands to be recovered before the polymeric polyurethane material is depolymerized to polyol components as well as isocyante or its amine components.

Additionally, in the said value chain return process, by the extraction of the phosphorous ester-based flame retardants also other not chemically to the polymer chain bonded additives as polymerization catalysts like tertiary amines and surfactants like siloxanes may also be extracted together with the phosphorous ester-based flame retardant. They can be obtained together with the phosphorous ester-based flame retardant after removal of the aprotic organic solvent used for the extraction and the obtained mixture of phosphorous ester-based flame, polymerization catalyst and surfactant used in the synthesis of new polyurethane rigid foams.

Thus, the present method enables re-utilization of the phosphorous ester-based flame retardant, the polymerization catalyst and the surfactants. The value chain return process of the invention for polyurethane rigid foams containing at least one phosphorous ester-based flame retardant and further non bonded additives results in a remaining polyurethane material were at least the phosphorous ester-based flame retardants were removed before via extraction with a suitable solvent, in particular an aprotic organic solvent.

Preferably, the remaining comminuted polyurethane or polyisocyanurate obtained in step b) of the process is subjected to a depolymerization and thus it is possible to recover both starting material components from the polyurethane. The polyurethane components are either recovered directly, for example the polyols, or are obtained as valuable synthesis building blocks such as polyamines which may readily be converted to polyisocyanates.

The process according to the present invention comprises steps a), and b), and optionally c) but may also comprise further steps. The process may for example comprise further purification steps or heat treatments. According to a further embodiment, the present invention is also directed to the process as disclosed above, wherein the process comprises further purification steps.

Suitable treatment steps are in principle known to the person skilled in the art. Suitable treatment and/or purification steps may be carried out between steps a) and b), or between steps b) and c). In the context of the present invention it is also possible that step b) is carried out directly after step a). It is also possible that step c) is carried out directly after step b).

According to the present invention, steps a) and b) might also be combined and carried out in the same apparatus. It is also possible that the composition provided in step a) might also comprise solvents, for example solvents which might be used in step b) of the process according to the present invention.

According to the present invention, at least one additive (A1) which is not chemically bonded to the polymer chain selected from the group consisting of phosphorous ester-based flame retardants, polymerization catalysts and surfactants is extracted. According to the present invention, phosphorous ester-based flame retardants, polymerization catalysts and surfactants which are usually used in polyurethane or polyisocyanurate rigid foams as additives which are not bonded to the polymer chain may be extracted.

Generally, phosphorous ester-based flame retardants used for polyurethane rigid foams, e.g. for constructions applications, conform to compounds of general formula (i):

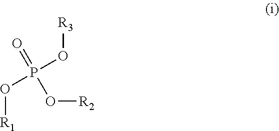

wherein R¹ and R² is independently of one another selected from C₁-C₁₂-alkyl, C₅-C₈-cycloalkyl and aryl, wherein
the C₁-C₁₂-alkyl is unsubstituted or carries 1, 2, 3, 4 or 5 identical or different substituents selected from hydroxy and halogen, such as Cl or Br, and
the C₅-C₈-cycloalkyl or aryl are unsubstituted or carry 1, 2, 3, 4 or 5 identical or different substituents selected from alkyl, hydroxy and halogen, such as Cl or Br, and
wherein R³ is selected from C₁-C₁₂-alkyl, C₅-C₈-cycloalkyl and aryl, wherein
the C₁-C₁₂-alkyl is unsubstituted or carries 1, 2, 3, 4 or 5 identical or different substituents selected from hydroxy and halogen, such as Cl or Br, and
the C₅-C₈-cycloalkyl or aryl are unsubstituted or carry 1, 2, 3, 4 or 5 identical or different substituents selected from alkyl, hydroxy and halogen, such as Cl or Br, or
wherein R³ is selected from —O—C₁-C₁₂-alkyl, —O—C₅-C₈-cycloalkyl and —O-aryl, wherein
the —O—C₁-C₁₂-alkyl is unsubstituted or carries 1, 2, 3, 4 or 5 identical or different substituents selected from hydroxy and halogen, such as Cl or Br, and
the —O—C₅-C₈-cycloalkyl or —O-aryl are unsubstituted or carry 1, 2, 3, 4 or 5 identical or different substituents selected from alkyl, hydroxy and halogen, such as Cl or Br.

Preferably, the aryl is selected from phenyl and naphthyl.

In an embodiment, the phosphorous ester-based flame retardant is selected from tris(2-chloroethyl)phosphate, tris(chloroisopropyl)phosphate, tris(1,3-dichloro-2-propyl)phosphate, tris(2-ethylhexyl)phosphate, triethylphosphate, tricresylphosphate, tris-(2,3-dibromo)phosphate, tetrakis-(2-chlorethyl)-ethylenediphosphate, dimethylphosphonate, dimethylpropylphosphonate, diphenylcresylphosphate, and mixtures thereof.

Therefore, according to a further embodiment, the present invention is also directed to the process as disclosed above, wherein the at least one phosphorous ester-based flame retardant is selected from the group consisting of tris(2-chloroethyl)phosphate, tris(chloroisopropyl)phosphate, tris(1,3-dichloro-2-propyl)phosphate, tris(2-ethylhexyl)phosphate, tricresylphosphate, tris-(2,3-dibromo)phosphate, tetrakis-(2-chlorethyl)-ethylenediphosphate, dimethylphosphonate, dimethylpropylphosphonate, diphenylcresylphosphate, triethylphosphate, and mixtures thereof.

Suitably, the phosphorous ester-based flame retardant is present in the polyurethane rigid foams in a content of 1 to 15 wt.-%, preferably 3 to 10 wt.-%, more preferably 5 to 8 wt.-%.

Suitably, the polymerization catalyst is present in the polyurethane rigid or polyisocyanurate foams in a content of 0.1 to 10 wt.-%, preferably 0.25 to 5 wt.-%, more preferably 0.5 to 2.5 wt.-%. Typically, the surfactant is present in the polyurethane rigid or polyisocyanurate foams in a content of 0.1 to 8 wt.-%, preferably 0.25 to 5 wt.-%, more preferably 0.5 to 2.5 wt.-%

Besides the phosphorous ester-based flame retardants, polyurethane rigid foams typically also contain polymerization catalysts such as trialkylamines as well as surfactants such as siloxanes, which could also be extracted in the step were the flame retardants are extracted and obtained in a mixture with them after removing the extraction solvent, preferably by distillation. Suitable methods for separating the respective compounds are known to the person skilled in the art.

According to a further embodiment, the present invention is also directed to the process as disclosed above, wherein the at least one polymerization catalysts is selected from the group consisting of tertiary amines.

Preferably, the polymerization catalyst is selected from of tertiary amines such as for example triethylamine, tributylamine, dimethylbenzylamin, dicyclohexylmethyla-min, dimethylcyclohexylamine, N,N,N′,N′-tetramethyldiaminodiethylether, Bis-(dimethylaminopropyl)-harnstoff, N-methyl- or N-ethylmorpholin, N-cyclohexyl-morpholin, N,N,N′,N′-tetrame thylethylendiamine, N,N,N,N-tetramethylbutandiamine, N,N,N,N-tetramethylhexandiamine-1,6, pentamethyldiethylentriamine, bis(2-dimethylaminoethyl)ether, dimethylpiperazin, N-dimethyl-aminoethylpiperidin, 1,2-dimethylimidazol, 1-azabicyclo-(2,2,0)-octan, 1,4-diazabicyclo.¬(2,2,2).octan (Dabco) and alkanolamine compounds such as triethanolamine, triisopropanolamine, N-methyl- und N-ethyldiethanolamine, dimethylaminoethanol, 2-(N,N-dimethylaminoethoxy)-ethanol, N,N′,N″-tris-(dialkylaminoalkyl) hexahydrotriazine, z.B. N,N′,N″-tris-(dimethylamino-propyl)-s-hexahydrotriazin, und triethylendiamine.

According to a further embodiment, the present invention is also directed to the process as disclosed above, wherein the at least one surfactant is selected from the group consisting of silicone-based cell stabilizers.

Silicone-based cell stabilizers comprise silicone-based compounds which reduce the surface tension of the polyesterols. These compounds are preferably compounds which have amphiphilic structure, and this means that they have two molecular moieties having different polarity. It is preferable that the silicone-based cell stabilizer has one molecular moiety having organosilicon units, an example being dimethylsiloxane or methylphenylsiloxane, and has one molecular moiety having a chemical structure which has some similarity to the polyols used. These are preferably polyoxyalkylene units. The silicone-based cell stabilizers particularly preferably comprise polysiloxane-polyoxyalkylene block copolymers having less than 75% by weight of oxyethylene content, based on the total content of polyoxyalkylene units. These preferably comprise polyethylene oxide units and/or polypropylene oxide units. The molar mass of the polyoxyalkylene side chains is preferably at least 1000 g/mol of side chains. These compounds are known and are described by way of example in Plastics handbook, volume 7, Polyurethane, Carl Hanser Verlag, 3rd edition 1993, chapter 3.4.4.2, and by way of example they can be produced via reaction of siloxane, such as polydimethylsiloxane, with polyoxyalkylene, in particular with polyethylene oxide, with polypropylene oxide, or with copolymers of polyethylene oxide and polypropylene oxide used. It is possible here to obtain polysiloxane-polyoxyalkylene block copolymers which has the oxyalkylene chain as terminal group or as one or more side chains. The silicone-based cell stabilizers (e) can have OH groups, but are preferably free from OH groups. This can be achieved by using monofunctional alcohols, such as butanol, as starter to produce the polyoxyalkylenes. By way of example, silicone-based cell stabilizers used can comprise known foam stabilizers based on silicones, e.g. Niax Silicone L1501, L 1505, L1540, L 1593, L 1602, or L 1609 from Monentive; Dabco® DC 193, Dabco® DC 3041, Dabco® DC 3042, Dabco® DC 3043, Dabco® DC 5000, Dabco® DC 5169, Dabco® DC 2525, Dabco® DC 2584, or Dabco® DC 5160 from Air Products; Tegostab® BF 2270, Tegostab® BF 2370, Tegostab® BF 2470, Tegostab® B 8110, Tegostab® B 8225, Tegostab® B 8255, Tegostab® B 8317, Tegostab® B 8325, Tegostab® B 8905, Tegostab® B 8946 PF, Tegostab® B 8948, Tegostab® B 8950, Tegostab® B 8952, Tegostab® B 8960, Tegostab® B 8498 or Tegostab® B 8486 from Evonik.

According to the invention, the extraction of the additive (A1) is carried out using a suitable solvent. Suitable solvents are in principle known and comprise for example organic aprotic solvents, water, polyols, and alcohols. Suitable polyols include those which might also be used as starting materials for the preparation of polyisocyanates or polyisocyanurates, such as for example diethylenglycol (DEG) or dipropylenglycol (DPG).

According to the present invention, the mixture of solvent and the additive (A1) obtained in the extraction step might also be directly used in a process for the preparation of a polyurethane or polyisocyanaturate without further purification steps.

According to a further embodiment, the present invention is also directed to the process as disclosed above, wherein the solvent is selected from organic aprotic solvents, water, polyols, and alcohols.

According to the invention, the extraction of the phosphorous ester-based flame retardant is preferably carried out using an organic aprotic solvent. Suitable solvents are in principle known to the person skilled in the art. In principle, any solvent may be used which is suitable to dissolve the phosphorous ester-based flame retardant but will not depolymerize the polyurethane polymer chain under the extraction conditions. For an economic process, preferably an organic solvent is selected with a boiling point at ambient pressure below 200° C., preferably below 150° C.

Suitable solvents might preferably have a dipol moment of less than 10*10⁻³⁰ Cm.

In one embodiment, the organic aprotic solvent is selected from aliphatic hydrocarbons, halogenated hydrocarbons, ethers, aromatic hydrocarbons, esters, ketones and mixtures thereof.

Therefore, according to a further embodiment, the present invention is also directed to the process as disclosed above, wherein organic aprotic solvent is selected from aliphatic hydrocarbons, halogenated hydrocarbons, ethers, aromatic hydrocarbons, esters, ketones and mixtures thereof.

Suitable aliphatic hydrocarbons are selected from pentane and its isomers, hexane and its isomers, heptane and it's isomers, octane and its isomers, cyclopentane, methyl-cyclopentane, cyclohexane and methylcyclohexane and mixtures thereof.

Suitable halogenated hydrocarbons are selected from dichloromethane, chloroform, 1,2-dichloroethane, 1,1,1-trichloroethane, 1,1,2,2-tetrachlroethane and mixtures thereof.

Suitable ethers are selected from tetrahydrofuran, 1,4-dioxane, anisole, diethyl ether, diisopropyl ether, dibutyl ether, methyl tert-butyl ether (MTBE) and diethylene glycol dimethyl ether and mixtures thereof.

Suitable aromatic hydrocarbons are selected from benzene, toluene, ortho-xylene, meta-xylene, para-xylene, ethylbenzene, mesitylene and chlorobenzene and mixtures thereof.

Suitable esters are selected from methylformate, methylacetate, ethylacetate and butylacetate and mixtures thereof.

Suitable ketones are selected from acetone, methylethylketone, diethylketone, cylopentanone and mixtures thereof.

If desired, mixtures of two or more of the afore-mentioned organic aprotic solvents may be used.

In a preferred embodiment, the extraction solvent is selected from cyclohexane, methylcyclopentane, methylcyclohexane, THF, MTBE, toluene, acetone and mixtures thereof.

Suitably, the ratio of solvent, in particular organic aprotic solvent and polyurethane rigid foam is in the range of 0.1 to 100 L solvent per 1 kg polyurethane rigid foam, preferably 1 to 20 L per 1 kg.

According to the present invention, the extraction according to step b) is carried out at a temperature below 190° C. To allow an efficient and fast extraction, extraction preferably is carried out at elevated reaction temperatures of at least 20° C. but not higher than 190° C. to prevent decomposition of the PU polymer chain, preferably from 50 to 180° C., in particular 80 to 170° C., most preferably from 100-160° C.

Therefore, according to a further embodiment, the present invention is also directed to the process as disclosed above, wherein the extraction is carried out at a temperature in the range from 20 to 190° C.

If solvents are used in the extraction at temperatures above their boiling point at ambient pressure, the extraction occurs in a pressure vessel, e.g. an autoclave at the then given vapor pressure of the used solvent at the chosen extraction temperature.

The inventive process for extracting the additive (A1), in particular the phosphorus ester based flame retardants may be carried out in customary devices and/or known to the person skilled in the art for extractions in which the spend polyurethane is extracted with the liquid phase. For the inventive process, it is in principle possible to use any equipment which is fundamentally suitable for the extraction of a solid with a liquid at the stated temperatures and the stated pressures. For suitable equipment for liquid-solid extractions see e.g.: Liquid-Solid Extraction, in Ullmann's Encyclopedia of Industrial Chemistry, 2012, Wiley-VCH Verlag GmbH & Co. KGaA, DOI 10.1002/1436007.b03_07.pub2. Suitable examples include, e.g., Rotating Extractors, Pot Extractors, autoclave extractors, extraction columns, bucket-elevator extractors, carousel extractors, sliding-cell extractors. The supply of polyurethane rigid foam and solvent may take place simultaneously or separately from one another. The reaction may be carried out discontinuously in batch mode or continuously, semi-continuously with recycle of the solvent or without recycle. The average residence time in the reaction space may be varied in a wide range, preferably in the range from 15 minutes to 100 h, more preferably in the range from 1 to 50 h.

In the extraction according to step b), the additive (A1), in particular the phosphorous ester-based flame retardant is obtained. Preferably, also further non bonded components are extracted from the polyurethane such as catalyst and surfactants. In case the phosphorous ester-based flame retardant is extracted together with further components, suitable separation steps might be carried out to obtain the different components. It is also possible that separation and purification steps such as washing steps are combined.

Therefore, according to a further embodiment, the present invention is also directed to the process as disclosed above, wherein further additives selected from the group consisting of polymerization catalysts and surfactants are extracted together with the phosphorous ester-based flame retardant.

Therefore, according to a further embodiment, the present invention is also directed to the process as disclosed above, wherein the further additives are selected from tertiary amines as polymerization catalysts and siloxanes as surfactants.

In step b), the remaining comminuted polyurethane or polyisocyanurate is obtained which might be subjected to further steps. In the context of the present invention, it is preferred to subject the remaining comminuted polyurethane or polyisocyanurate to a treatment suitable to obtain the individual building blocks which in turn might be separated and reused, for example for the preparation of polyurethanes.

The process of the present invention might also comprise further steps. Suitable purification steps include for example washing steps and drying steps.

Preferably, the process of the present invention also comprises step c) of depolymerization of the remaining comminuted polyurethane. As set out above. Suitable conditions for the depolymerization are in principle known to the person skilled in the art. Preferably, depolymerization according to step c) is carried out by a method selected from hydrolysis, glycolysis, hydrogenation or by aminolysis.

Preferably, hydrolysis is carried out in the presence of a catalytic active component, ionic liquids or phase transfer catalysts or a base. The resulting products of the depolymerization may be separated using suitable separation techniques.

According to a further embodiment, the present invention is also directed to the process as disclosed above, wherein the hydrolysis is carried out in the presence of a catalytic active component, ionic liquids or phase transfer catalysts or a base.

Also methods for depolymerization by glycolysis are in principle known. Preferably, glycolysis is carreid out in the presentce of a base. Therefore, according to a further embodiment, the present invention is also directed to the process as disclosed above, wherein the glycolysis is carried out in the presence of a metal catalyst.

Suitable methods for depolymerization by hydrogenation include the hydrogenation in the presence of a hydrogenation catalyst. Therefore, according to a further embodiment, the present invention is also directed to the process as disclosed above, wherein the hydrogenation is carried out in the presence of a hydrogenation catalyst.

The said remaining polyurethane material can for example be cleaved to the synthesis building blocks polyols as well as polyamines using known protic conditions for the depolymerization of polyurethanes such as hydrolysis, aminolysis followed by hydrolysis, glycolysis as given for rigid foams in Waster Management, 2018, 76, 147-171.

Another possibility is the depolymerization of the remaining polyurethane by hydrolysis with water in the presence of reusable organic nitrogen bases such as 1-alkylimidazoles in combination with water as described in WO2010/130652A2, or pyridine/water or the combination of nitrogencontaining ionic liquids and water to allow the hydrolysis at lower temperatures and shorter reaction times.

Another possibility is the depolymerization of the remaining polyurethane by hydrogenation in the presence of transition-metal containing hydrogenation catalysts as for example described in ChemSusChem, 2021, DOI: 10.1002/cssc.202101705 or ChemSusChem, 2021, DOI: 10.1002/cssc.202101705.

Usually, the depolymerization results in a mixture of components which might be separated using suitable separation techniques.

Said products of the depolymerization of the polyurethane after the extraction of the flame retardants might contain a polyamine and optionally a polyol from the polyurethane rigid foam.

The process according to the present invention might also comprise step d) of separation of the isocyanate component or the amine derivative thereof and the polyol components.

The work-up of the depolymerization product, in particular the isolation of the polyamine and the polyol can be realized case dependent, for example by extractive work-up, precipitation of the amine component as a hydrochloride, as a urea (in case of an aminolysis), chromatography or distillation under reduced pressure. Preferably, the work up comprises several steps.

In work-up by distillation, compounds are separated according to their volatility, with more volatile compounds being separated first. Additives, water or solvents used in the depolymerization can also be removed via distillation prior further work-up of the polyol-polyamine mixtures. Generally, the “volatility” of a liquid may be described using its vapor pressure, wherein a high vapor pressure indicates a high volatility, and vice versa.

In the event that the polyamine is more volatile than the polyol as it is for example the case for TDA, MDA and NDA, the polyamine is recovered from the depolymerization product via distillation, preferably via distillation at reduced pressure. After distilling-off the polyamine, a distillation bottoms remains which contains the polyol.

Suitable conditions for the distillation are in principle known to the person skilled in the art.

Alternatively, the polyol may be recovered by extraction from the depolymerization mixture using a suitable extractant or a pair of extractants. It is also possible to precipitate the polyamine component in the form of it's hydrochloride by adding HCl and extracting the polyol component with a suitable solvent for example as described in DE2854940A1, which is preferably dissolving the polyol component but not the hydrochlorides of the polyamine component. The hydrochloride of the polyamine component can after separation then either be transferred to the free polyamine by adding a base but also directly used in the phosgenation to generate new polyisocyanates for the polyurethane synthesize as described in CN107337615B. In case of MDA*HCl or PMDA*HCl the hydrochloride can be used in MDA/PMDA synthesis step by condensation of aniline and formaldehyde.

It is understood that the separation process described above can be combined with any of the various embodiments of the inventive process described herein.

According to step a), a comminuted polyurethane or polyisocyanurate rigid foam containing at least one phosphorous ester-based flame retardant is used. In principle, the properties of the foams might vary in broad ranges.

The polyurethane or polyisocyanurate rigid foams used in the present invention are preferably obtained from items produced from polyurethane rigid foams at a time after use for the purpose for which they were manufactured or polyurethane rigid foam waste from production processes. Before subjecting to the process of the present invention, the items may be subjected to mechanical comminution. That is, further sorting and bringing the items into appropriate sizes, e.g., by shredding, sieving or separation by rates of density, i.e. by air, a liquid or magnetically. Optionally, these fragments may then undergo processes to eliminate impurities, e.g. paper labels. Furthermore, steps to remove blowing agents may be included in the process. Suitable methods are in principle known to the person skilled in the art.

The process according to the present invention is also applicable to polyurethane rigid foam waste containing at least one additive (A1), in particular at least one phosphorous ester-based flame retardant as starting materials. Herein, the term “polyurethane rigid foam waste” includes end-of-life polyurethane rigid foams and production rejects of PU rigid foams or waste produced during construction. In this context, the term “spent polyurethane rigid foam” denotes an item produced from a polyurethane rigid foam at a time when it has already been used for the purpose for which it was manufactured. “Production rejects of polyurethane rigid foams” denotes polyurethane rigid foam waste occurring in production processes of PU rigid foams.

Generally, polyurethane rigid foams are produced by a reaction between a polyisocyanate component and a polyol component. Further materials, such as phosphorous ester-based flame retardands, polymerization catalysts as tertiary amines and surfactands as siloxanes are added in the production process of the polymers.

The properties of a polyurethane rigid foam are influenced by the types of polyisocyanate and polyol components used. For example, the starting materials may influence the crosslinking of the polymers meaning that the polymer consists of a three-dimensional network. Rigid polymers are obtained from short chains with many crosslinks.

Industrially and consequently in large quantities, especially methylenedi (phenylisocyanate) (MDI) or its polymeric forms are used as polyisocyanate components for the production of PU rigid foams.

For a representative composition of these PU rigid foams, see WO 2015/121057 and WO 2013/139781.

Organic polyisocyanates that can be used in the preparation of polyurethanes are any of the known organic di- and polyisocyanates, preferably aromatic polyfunctional isocyanates.

Individual examples which may be mentioned are tolylene 2,4 and 2,6-diisocyanate (TDI) and the corresponding isomer mixtures, diphenylmethane 4,4′, 2,4′ and 2,2′ diisocyanate (MDI) and the corresponding isomer mixtures, mixtures composed of diphenylmethane 4,4′- and 2,4′-diisocyanates, polyphenyl polymethylene polyisocyanates, mixtures composed of diphenylmethane 4,4′-, 2,4′- and 2,2′-diisocyanates and of polyphenyl polymethylene polyisocyanates (crude MDI) and mixtures composed of crude MDI and of tolylene diisocyanates. The organic di- and polyisocyanates may be used individually or in the form of mixtures.

Use is also often made of what are known as modified polyfunctional isocyanates, i.e. products obtained via chemical reaction of organic di and/or polyisocyanates. By way of example, mention may be made of di and/or polyisocyanates containing uretdione groups, carbamate groups, isocyanurate groups, carbodiimide groups, allophanate groups and/or urethane groups. The modified polyisocyanates may, if appropriate, be mixed with one another or with unmodified organic polyisocyanates, such as diphenylmethane 2,4′ or 4,4′-diisocyanate, crude MDI, or tolylene 2,4 and/or 2,6-diisocyanate.

Compounds which may be used for the preparation of polyurethanes which have at least two hydrogen atoms reactive toward isocyanate groups are those which bear at least two reactive groups selected from OH groups, SH groups, NH groups, NH2 groups, and acidic CH groups. Preferably polyols are used and in particular polyether alcohols and/or polyester alcohols whose OH numbers are in the range from 25 to 800 mg KOH/g.

The polyester alcohols used are mostly prepared via condensation of polyhydric alcohols, preferably diols, having from 2 to 12 carbon atoms, preferably from 2 to 6 carbon atoms, with polybasic carboxylic acids having from 2 to 12 carbon atoms, e.g. succinic acid, glutaric acid, adipic acid, suberic acid, azelaic acid, sebacic acid, decanedicarboxylic acid, maleic acid, fumaric acid, or preferably phthalic acid, isophthalic acid, terephthalic acid, or the isomeric naphthalenedicarboxylic acids. The polyesterols used mostly have a functionality of from 1.5 to 4.

Polyether polyols particularly used are those prepared by known processes, e.g. via anionic polymerization of alkylene oxides onto H-functional starter substances in the presence of catalysts, preferably alkali metal hydroxides or double-metal-cyanide catalysts (DMC catalysts). Alkylene oxides used are mostly ethylene oxide or propylene oxide, or else tetrahydrofuran, various butylene oxides, or styrene oxide, and preferably pure propylene 1,2-oxide. The alkylene oxides can be used alone, in alternating succession, or in the form of a mixture. Starter substances particularly used are compounds having at least 2, preferably from 2 to 8, hydroxy groups or having at least two primary amino groups in the molecule. Starter substances used and having at least 2, preferably from 2 to 8, hydroxy groups in the molecule are preferably trimethylolpropane, glycerol, pentaerythritol, sugar compounds, such as glucose, sorbitol, mannitol, and sucrose, polyhydric phenols, resols, e.g. oligomeric condensates composed of phenol and formaldehyde, and Mannich condensates composed of phenols, of formaldehyde, and of dialkanolamines, and also melamine. Starter substances used and having at least two primary amino groups in the molecule are preferably aromatic di and/or polyamines, such as phenylenediamines, 2,3-, 2,4-, 3,4, and 2,6 tolylenediamine, and 4,4′-, 2,4′-, and 2,2′ diaminodiphenyl-methane, and also aliphatic di and polyamines, such as ethylenediamine. The preferred functionality of the polyether polyols is from 2 to 8 and their preferred hydroxy numbers are from 25 to 800 mg KOH/g, in particular from 150 to 570 mg KOH/g.

Other compounds having at least two hydrogen atoms reactive toward isocyanate are crosslinking agents and chain extenders which may be used concomitantly, if appropriate. Addition of difunctional chain extenders, trifunctional or higher-functionality crosslinking agents, or else, if appropriate, mixtures of these can prove advantageous for modification of mechanical properties. Chain extenders and/or crosslinking agents preferably used are alkanolamines and in particular diols and/or triols with molecular weights below 400, preferably from 60 to 300. The amount advantageously used of chain extenders, crosslinking agents, or mixtures of these is from 1 to 20% by weight, preferably from 2 to 5% by weight, based on the polyol component.

Common polyols used in huge quantities are, e.g., polyester polyols, low molecular weight polyols such as ethylene glycol or propylene glycol, or high molecular weight polyether polyols based on glycerol, ethylene glycol, polypropylene glycol, polytetramethylene glycol, and polyesterpolyols.

In an embodiment, the polyurethane rigid foams are selected from aromatic isocyanate-based polyurethane rigid foams, preferably from methylenedi (phenylisocyanate)-based polyurethane rigid foams, and polymeric methylenedi (phenylisocyanate)-based polyurethane rigid foams. Methylenedi (phenylisocyanate)-based polyurethane rigid foams and polymeric or oligomeric methylenedi (phenylisocyanate)-based polyurethane rigid foams are especially preferred.

Therefore, according to a further embodiment, the present invention is also directed to the process as disclosed above, wherein the polyurethane rigid foams are selected from the group consisting of aromatic isocyanate-based polyurethane rigid foams, preferably from methylenedi(phenylisocyanate)-based polyurethane rigid foams, polymeric methylenedi(phenylisocyanate)-based polyurethane rigid foams and 1 polyurethane rigid foams.

Polyfunctional isocyanates based on diphenylmethane diisocyanate (MDI) are in particular 2,2′-MDI or 2,4′-MDI or 4,4′-MDI or oligomeric MDI, which is also known as polyphenylpolymethylene polyisocyanate, or mixtures of two or three aforementioned diphenylmethane diisocyanates, or crude MDI, which is generated in the production of MDI, or mixtures of at least one oligomer of MDI and at least one of the aforementioned low molecular weight MDI derivatives.

In a methylenedi(phenyl-isocyanate)-based polyurethane rigid foam, isomeric mixtures of 4,4′-, 2,4′- and 2,2′-diphenylmethane diisocyanates; isomeric mixtures of 4,4′- and 2,2′-diphenylmethane diisocyanates; polyphenylpolymethylene polyisocyanates; or mixtures of 4,4′-, 2,4′- and 2,2′-diphenylmethane diisocyanates and polyphenylpolymethylene polyisocyanates can also be used.

Use is frequently also made of modified polyisocyanates, i.e., products obtained by chemical reaction of organic polyisocyanates and having two or more reactive isocyanate groups per molecule. Polyisocyanates comprising ester, urea, biuret, allophanate, carbodiimide, isocyanurate, uretdione, carbamate and/or urethane groups may be mentioned in particular.

Aromatic isocyanates are compounds wherein the isocyanate functional group is directly bound to the aromatic core. In comparison, a compound such as p-xylylene diisocyanate is not considered an aromatic isocyanate because the isocyanate functional groups are bound to a methylene spacer and, hence, not directly to the aromatic core.

After depolymerization, the process of the invention typically yields a polyamine comprising an amino group attached to the carbon atom to which in the initial polyisocyanate a isocyanate group was bound, e.g., methylene diphenyl diamines, oligomeric and polymeric methylene phenylene amine and toluenediamines (TDA), in particular 2,4-toluenediamine or 2,6-toluenediamine or 1,5-naphthyldiamine (NDA). The commonly used polyols as described above preferably also can be re-isolated. Thus, the process preferably further yields, e.g., polyester polyols, low molecular weight polyols such as ethylene glycol or propylene glycol, or high molecular weight polyether polyols based on glycerol, sorbitol, ethylene glycol, polypropylene glycol and polytetramethylene glycol.

According to a further aspect, the present invention is also directed to a phosphorous ester-based flame retardant, polymerization catalyst or surfactant obtained or obtainable according to the process as disclosed above, in particular a phosphorous ester-based flame retardant obtained or obtainable according to the process as disclosed above. The present invention is also directed to the polyol composition obtained or obtainable according to the process as disclosed above.

Preferably, the phosphorous ester-based flame retardant, polymerization catalyst or surfactant obtained and also the components of the polyurethanes obtained may be reused, for example in processes for preparing polyurethanes or polyisocyanurates.

Preferably, also the polyol composition obtained may be reused, for example in processes for preparing polyurethanes or polyisocyanurates.

Therefore, according to a further aspect, the present invention is also directed to the use of the phosphorous ester-based flame retardant, polymerization catalyst or surfactant according to the present invention or the phosphorous ester-based flame retardant, polymerization catalyst or surfactant obtained or obtainable according to the process as disclosed above for the preparation of polyurethanes or polyisocyanurates.

Further embodiments of the present invention can be found in the claims and the examples. It will be appreciated that the features of the subject matter/processes/uses according to the invention that are mentioned above and elucidated below are usable not only in the combination specified in each case but also in other combinations without departing from the scope of the invention. For example, the combination of a preferred feature with a particularly preferred feature or of a feature not characterized further with a particularly preferred feature etc. is thus also encompassed im-plicitly even if this combination is not mentioned explicitly.

Illustrative embodiments of the present invention are listed below, but these do not restrict the present invention. In particular, the present invention also encompasses those embodiments which result from the dependency references and hence combinations specified hereinafter.
1. A value chain return process for polyurethane and polyisocyanurate rigid foams containing at least one additive (A1) which is not chemically bonded to the polymer chain selected from the group consisting of phosphorous ester-based flame retardants, polymerization catalysts and surfactants comprising the steps of
   a) providing a composition comprising a comminuted polyurethane or polyisocyanurate rigid foam, wherein the comminuted foam has a content of intact cells of less than 10%, based on the number of intact cells of the not comminuted polyurethane or polyisocyanurate rigid foam,
   b) extraction of the additive (A1) with a solvent at a temperature below 190° C.
2. The process according to embodiment 1 wherein the process further comprises step c)
   c) depolymerization of the comminuted polyurethane or polyisocyanurate obtained in step b).
3. The process according embodiment 2, wherein the depolymerization according to step c) is carried out by a method selected from hydrolysis, glycolysis, hydrogenation or by aminolysis.
4. The process according embodiment 3, wherein the hydrolysis is carried out in the presence of a catalytic active component, ionic liquids or phase transfer catalysts or a base.
5. The process according embodiment 4, wherein the process further comprises a step d)
   d) separation of the isocyanate component or the amine derivative thereof and the polyol components.
6. The process according embodiment 3, wherein the glycolysis is carried out in the presence of a metal catalyst.
7. The process according embodiment 3, wherein the hydrogenation is carried out in the presence of hydrogenation catalyst.
8. The process according to any one of embodiments 1 to 7, wherein the polyurethane rigid foams are selected from the group consisting of aromatic isocyanate-based polyurethane rigid foams, preferably from methylenedi (phenylisocyanate)-based polyurethane rigid foams, polymeric methylenedi (phenylisocyanate)-based polyurethane rigid foams.
9. The process according to any one of embodiments 1 to 8, wherein the at least one phosphorous ester-based flame retardant is selected from the group consisting of tris(2-chloroethyl)phosphate, tris(chloroisopropyl)phosphate, tris(1,3-dichloro-2-propyl)phosphate, tris(2-ethylhexyl)phosphate, tricresylphosphate, tris-(2,3-dibromo)phosphate, tetrakis-(2-chlorethyl)-ethylenediphosphate, dimethylphosphonate, dimethylpropylphosphonate, diphenylcresylphosphate, triethylphosphate, and mixtures thereof.
10. The process according to any one of embodiments 1 to 9, wherein the at least one polymerization catalysts is selected from the group consisting of tertiary amines.
11. The process according to any one of embodiments 1 to 10, wherein the at least one surfactant is selected from the group consisting of silicone-based cell stabilizers.
12. The process according to any one of embodiments 1 to 11, wherein the solvent is selected from organic aprotic solvents, water, polyols, and alcohols.
13. The process according to embodiment 12, wherein organic aprotic solvent is selected from aliphatic hydrocarbons, halogenated hydrocarbons, ethers, aromatic hydrocarbons, esters, ketones and mixtures thereof.
14. The process according to any one of embodiments 1 to 6, wherein the extraction is carried out at a temperature in the range from 20 to 190° C.
15. Polyol composition obtained or obtainable according to the process of any one of embodiments 1 to 14.
16. Use of the phosphorous ester-based flame retardant obtained or obtainable according to the process of any one of embodiments 1 to 14 for the preparation of polyurethanes or polyisocyanurates.
17. Use of the polymerization catalyst obtained or obtainable according to the process of any one of embodiments 1 to 14 for the preparation of polyurethanes or polyisocyanurates.
18. Use of the stabilizer obtained or obtainable according to the process of any one of embodiments 1 to 14 for the preparation of polyurethanes or polyisocyanurates.
19. Use of the polyol composition according to embodiment 15 or a polyol composition obtained or obtainable according to the process of any one of embodiments 1 to 14 for the preparation of polyurethanes or polyisocyanurates.
20. A value chain return process for polyurethane and polyisocyanurate rigid foams containing at least one additive (A1) which is not chemically bonded to the polymer chain selected from the group consisting of phosphorous ester-based flame retardants, polymerization catalysts and surfactants comprising the steps of
   a) providing a composition comprising a comminuted polyurethane or polyisocyanurate rigid foam, wherein the comminuted foam has a content of intact cells of less than 10%, based on the number of intact cells of the not comminuted polyurethane or polyisocyanurate rigid foam,
   b) extraction of the additive (A1) with a solvent at a temperature below 190° C.,
   c) depolymerization of the comminuted polyurethane or polyisocyanurate obtained in step b).
21. A value chain return process for polyurethane and polyisocyanurate rigid foams containing at least one additive (A1) which is not chemically bonded to the polymer chain selected from the group consisting of phosphorous ester-based flame retardants, polymerization catalysts and surfactants comprising the steps of
   a) providing a composition comprising a comminuted polyurethane or polyisocyanurate rigid foam, wherein the comminuted foam has a content of intact cells of less than 10%, based on the number of intact cells of the not comminuted polyurethane or polyisocyanurate rigid foam,
   b) extraction of the additive (A1) with a solvent at a temperature below 190° C., wherein the solvent is selected from organic aprotic solvents, water, polyols, and alcohols.
22. The process according to embodiment 21 wherein the process further comprises step c)
   c) depolymerization of the comminuted polyurethane or polyisocyanurate obtained in step b).
23. The process according embodiment 22, wherein the depolymerization according to step c) is carried out by a method selected from hydrolysis, glycolysis, hydrogenation or by aminolysis.
24. The process according embodiment 23, wherein the hydrolysis is carried out in the presence of a catalytic active component, ionic liquids or phase transfer catalysts or a base.
25. The process according embodiment 24, wherein the process further comprises a step d)
   d) separation of the isocyanate component or the amine derivative thereof and the polyol components.
26. The process according embodiment 23, wherein the glycolysis is carried out in the presence of a metal catalyst.
27. The process according embodiment 23, wherein the hydrogenation is carried out in the presence of hydrogenation catalyst.
28. The process according to any one of embodiments 21 to 27, wherein the polyurethane rigid foams are selected from the group consisting of aromatic isocyanate-based polyurethane rigid foams, preferably from methylenedi (phenylisocyanate)-based polyurethane rigid foams, polymeric methylenedi (phenylisocyanate)-based polyurethane rigid foams.
29. The process according to any one of embodiments 21 to 28, wherein the at least one phosphorous ester-based flame retardant is selected from the group consisting of tris(2-chloroethyl)phosphate, tris(chloroisopropyl)phosphate, tris(1,3-dichloro-2-propyl)phosphate, tris(2-ethylhexyl)phosphate, tricresylphosphate, tris-(2,3-dibromo)phosphate, tetrakis-(2-chlorethyl)-ethylenediphosphate, dimethylphosphonate, dimethylpropylphosphonate, diphenylcresylphosphate, triethylphosphate, and mixtures thereof.
30. The process according to any one of embodiments 21 to 29, wherein the at least one polymerization catalysts is selected from the group consisting of tertiary amines.
31. The process according to any one of embodiments 21 to 30, wherein the at least one surfactant is selected from the group consisting of silicone-based cell stabilizers.
32. The process according to embodiment 21, wherein organic aprotic solvent is selected from aliphatic hydrocarbons, halogenated hydrocarbons, ethers, aromatic hydrocarbons, esters, ketones and mixtures thereof.

The present invention can be further explained and illustrated on the basis of the following examples. However, it will be understood that these examples are included merely for purposes of illustration and are not intended to limit the scope of the invention in any way.

### EXAMPLES

### 1. Materials Used

Polyol 1: polyetherol, obtained by propoxylation of a mixture of saccharose and glycerin with an OH number of 490.
Elastopir: polyisocyanurate rigid foam from BASF Polyurethanes obtained by reacting a polyol component (Elastopir 1132/509) containing P-containing flame retardant with Lupranat M50 (Index=330).
Elastocool polyurethane rigid foam from BASF Polyurethanes obtained by reacting a polyol component (Elastocool F 2030/310) with Lupranat M20 (Index=120).

### 2. General Description

In the extraction experiments, different PU rigid foams containing at least one phosphorous ester-based flame retartand were used. PU rigid foam Index 100 is based on 74 wt.-parts polyol 1, 20 wt.-parts TCPP (flame retardant tris(2-chloroisopropyl)phosphate), 3 wt.-parts Tegostab B 842045 (silicone surfactant available from Evonik Industries AG), 0.5 wt.-parts Lupragen N600 (a tertiary amine available from BASF SE, Germany), 2.5 wt.-parts water, 5 wt.-parts cyclopentane, and 100 wt.-parts Lupranat MP 102 (short chain prepolymer based on pure 4,4′-diphenylmethane diisocyanate available from BASF SE, Germany), containing therefore 9.4 wt.-% of the flame retardant TCPP in the final PU rigid foam. PU rigid foam Elastopir is based on 70% of polymeric-MDI and 25% of the Polyol component (polyesteroles and polyetherole mixtures), 3.5 wt % TCPP (tris(2-chloroisopropyl)phosphate)) flame retardant, and overall 2.5 wt % of the tertiary amine catalysts as well as the siloxanes surfactants as other extractable components besides the phosphorous ester based flame retardant.

As a comparison, also Elastocool, a PU rigid foam made of pMDI (60%) and Polyetherols was used, which does not contain an extractable phosphorous ester-based flame retardant as reference material to proof the stability of the PU polymeric chain under these conditions.

The rigid foams were used as a comminuted foam in form of a powder with a content of intact cells of less than 1%, based on the number of intact cells of the not comminuted rigid foam. The content of intact cells was determined using light microscopy.

### 3. Procedure for the Pre-Extraction of Flame Retardant

A 38 mL Ace tube (no stirring bar) was charged with polymer. The walls were rinsed with cyclohexane (CyH). The ace tube was closed and heated for the indicated time to the indicated temperature (pre-heated metal block, no stirring). After cooling to room temperature, the suspension was filtered over a suction filter. The remaining polymer was rinsed with additional cyclohexane (2×10 mL, 1×5 mL). The polymer was transferred to a vial and dried at 60° C. (oven) overnight yielding the amount of recovered polymer. The solvent of the filtrate was removed under reduced pressure (47° C., minimal pressure 60 mbar). The obtained colorless oil was analyzed by ¹H. ³¹P and ¹³C NMR spectroscopy (CDCl₃) as well as GC-FID.

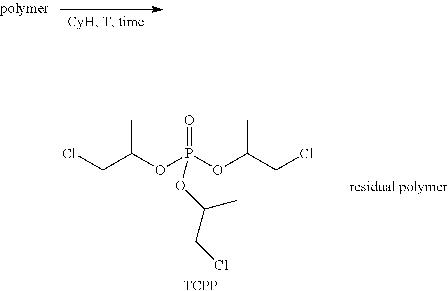

| | | | | | Polymer |
|---|---|---|---|---|---|
| Polymer used | Solvent | T | Time | Oil | recovered |
| [g] | [mL] | [° C.] | [h] | [g] | [g] |
| Index 100 (2.00) | CyH (40) | r.t. | 16 | <0.010 | 1.95 |
| Index 100 (2.00) | CyH (40) | 75 | 16 | 0.048 | 1.93 |
| Index 100 (1.35) | CyH (20) | 140 | 16 | 0.113^{[2]} | 1.24 |
| Index 100 (1.04) | CyH (15) | 150 | 16 | 0.123^{[2]} | 0.907 |
| Index 100 (10.1)^{[3]} | CyH (150) | 150 | 16 | 0.909^{[2]} | 9.23 |
| Index 100 (12.0)^{[3]} | CyH (180) | 150 | 16 | 1.07^{[2]} | 10.83 |
| Elastopir (1.00) | CyH (15) | 150 | 2 | 0.021^{[2]} | 0.948 |
| Elastopir (1.00) | CyH (15) | 150 | 16 | 0.030^{[2]} | 0.925 |
| Elastopir (8.00)^{[3]} | CyH (120) | 150 | 16 | 0.287^{[2]} | 7.73 |
| Elastocool (1.00) | CyH (15) | 150 | 16 | 0.003^{[4]} | 0.923 |

[1] The isolated oil contained residual solvent.
^{[2]}The isolated oil contains minor amounts of other unidentified species in addition to the flame retardant (TCPP) as main component.
^{[3]}The experiment was performed inside a 300 mL stainless-steel autoclave (Premex) fitted with a Teflon insert under stirring (750 RPM).
^{[4]}The isolated oil contains other unidentified species.
CyH = cyclohexane; RPM = rounds per minute.

Index 100 and Elastopir extracts contained flame retardant (TCPP-tris(2-chloroisopropyl)phosphate). Elastopir and Elastocool samples contained minor amounts of silicon stabilizers as well as minor amounts of amine catalysts.

### 4. Procedure for the Pre-Extraction of Flame Retardant Using Different Solvents

A 38 mL Ace tube (no stirring bar) was charged with polymer (1.00 g). The walls were rinsed with the indicated solvent. The ace tube was closed and heated for 16 hours to 150° C. (preheated metal block, no stirring). After cooling to room temperature, the suspension was filtered over a suction filter. The remaining polymer was rinsed with the indicated solvent (2×10 mL, 1×5 mL). The polymer was transferred to a vial and dried at 60° C. (oven) overnight yielding the amount of recovered polymer. The solvent of the filtrate was removed under reduced pressure (47° C., minimal pressure 60 mbar). The obtained colorless oil was analyzed by ¹H. ³¹P and ¹³C NMR spectroscopy (CDCl₃) as well as GC-FID.

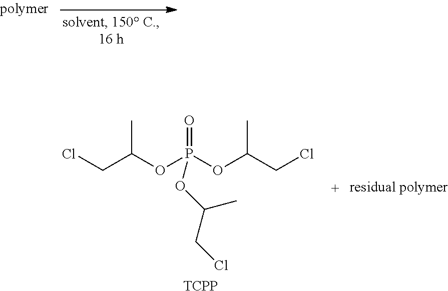

| | | | | | Polymer |
|---|---|---|---|---|---|
| PU rigid foam | Solvent | T | Time | Oil | recovered |
| [g] | [mL] | [° C.] | [h] | [g] | [g] |
| Index 100 (1.00) | EtOAc (15) | 150 | 16 | 0.161^{[2]} | 0.825 |
| Index 100 (1.00) | THF (15) | 150 | 16 | 0.257^{[1, 2]} | 0.696 |
| Index 100 (1.00) | PhMe (15) | 150 | 16 | 0.133^{[2]} | 0.849 |
| Index 100 (1.00) | EtOH (15) | 150 | 16 | 0.612^{[1, 2]} | 0.415 |
| Index 100 (1.00) | MTBE (15) | 150 | 16 | 0.114^{[2]} | 0.894 |
| Index 100 (1.00)^{[3]} | Acetone (15) | 150 | 16 | 0.157^{[2]} | 0.813 |
| Index 100 (2.04) | DCM (60) | r.t. | 0.5 | 0.196^{[2]} | 1.762 |
| Elastopir (2.01) | DCM (40) | r.t. | 0.5 | 0.084^{[2]} | 1.882 |
| Elastopir (2.00) | CPME (15) | r.t. | 16 | 0.020 | 1.663^{[4]} |
| Elastopir (1.00) | CPME (15) | 150 | 16 | 0.054^{[2]} | 0.938 |

^{[1]}The isolated oil contained residual solvent.
^{[2]}The isolated oil contains minor amounts of other unidentified species in addition to the flame retardant (TCPP) as main component.
^{[3]}The experiment was performed inside a stainless-steel autoclave (Premex) fitted with a Teflon insert under stirring (750 RPM).
^{[4]}Some polymer was lost during transferring.
EtOAc = ethyl acetate; THF = tetrahydrofuran; PhMe = toluene; EtOH = ethanol; MTBE = methyl-tert-butyl ether; DCM = dichloromethane; CPME = cyclopentyl methyl ether; RPM = rounds per minute.

Index 100 and Elastopir extracts contained flame retardant (TCPP-tris(2-chloroisopropyl)phosphate). Elastopir and Elastocool samples contained minor amounts of silicon stabilizers as well as minor amounts of amine catalysts.

### 5. Hydrolysis of Pre-Treated/Pre-Extracted Polymer Samples

In air, a stainless-steel autoclave (Premex Red) fitted with a Teflon insert was charged with pre-extracted Elastopir foam (7.70 g). The walls were rinsed with methylimidazole (80 mL) and water (8 mL). The autoclave was closed and heated overnight to 160° C. under stirring. After stirring for 18 hours at 160° C., the autoclave was cooled to room temperature and slowly opened to release residual CO₂ pressure. A clear purplish-brown solution was obtained. The solution was transferred to a round bottom flask and the autoclave was rinsed with additional methylimidazole (3×5 mL). The solvent was removed under reduced pressure (slow gradual heating to 100° C., 2.5·10⁻² mbar). The residue was dissolved in dry dichloromethane (20 mL) under argon and filtered (Whatman) to a 200 mL Schlenk tube. The flask was additionally rinsed with DCM (4×10 mL). No solid remained in the initial flask or on the filter. The brown solution was further diluted with DCM (90 mL, total volume of the solution=150 mL). An ethereal solution of HCl (2 M in Et₂O, 50 mL) was slowly added at room temperature. A voluminous yellow ocher precipitate could be observed. The suspension was transferred to a Schlenk filter frit (Ø 6.5 cm, ˜500 mL, filter grade 3). The remaining solid was washed with dry dichloromethane (6×40 mL). After drying overnight under reduced pressure (r.t., 1.4.10-2 mbar), the solid was transferred inside a glovebox and weighed. The isolated light yellowish-ocher solid (6.62 g) consists the amine fraction of the polymer isolated as hydrochloride salt. The solvent of the filtrate was removed under reduced pressure (49° C., min. pressure 55 mbar). The obtained dark brown oil (1.55 g) consists the polyol fraction after hydrolysis. All products were characterized by 1H and 13C NMR.

### 6. Comparative Example 1: Hydrolysis of as PU Rigid Foam in the Presence of a Phosphorous Ester-Based Flame Retardant

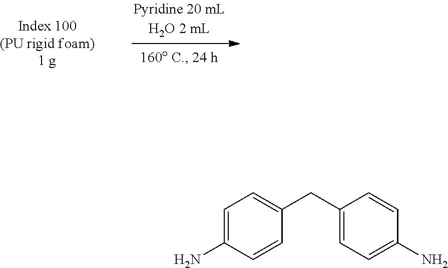 [SMILES: Nc1ccc(Cc2ccc(N)cc2)cc1]

After the reaction, a reaction mixture in the form of a dark brown solution was obtained which was free of solids. By analyzing said reaction mixture via GC/MS, 4,4′-methylenedianiline was detected. However, the reaction mixture did not contain a phosphorous ester-based flame retardant according to GC/MS or ³¹P NMR data. Thus, the phosphorous ester-based flame retardant was hydrolyzed under these conditions.

Experimental details: In air, a stainless-steel autoclave (Premex) fitted with a Teflon insert was charged with untreated PU rigid foam Index 100 (1.00 g). The walls were rinsed with pyridine (20 mL) and water (2 mL). The autoclave was closed and heated for 16 h to 160° C. After cooling to room temperature (ice-bath), the brown solution was filtered over a suction filter and the filter was rinsed with EtOH (3×5 mL). No solid remained on the filter. The solvent was removed under reduced pressure (45° C., min. pressure 60 mbar). According to ¹H and ³¹P NMR analysis, no flame retardant was detected in neither of the crude or isolated material.

### 7. Comparative Example 2: Hydrogenative Depolymerization of a Polyurethane Rigid Foam Containing a Phosphorous Ester-Based Flame Retardant Using MACHO Catalysts in the Protic Solvent Iso-Propanol

The results and conditions of the following procedure are summarized in table 2.

A stainless-steel autoclave (Premex) fitted with a Teflon insert was charged with PU rigid foam Index 100 (1.00 g). Inside a glovebox, catalyst and base were added. The walls were rinsed with iso-propanol and the autoclave was closed. Outside the glovebox, the autoclave was flushed with hydrogen gas (2×15 bar) and finally charged with hydrogen gas (50 bar). The autoclave was heated for 21 h to 180° C. under stirring (pre-heated metal block, 750 RPM). After cooling to room temperature (ice-bath), the residual pressure was carefully released. The suspension was filtered over a suction filter and the remaining solid was washed with dichloromethane (3×5 mL) and EtOH (3×5 mL). The solid, residual polymer was dried under reduced pressure (r.t., <5.0·10⁻² mbar) and used for the determination of the conversion (conversion=[(polymer used−polymer recovered)/polymer used]×100). After removal of the solvent of the filtrate under reduced pressure (45° C., min. pressure 80 mbar), the residue was redissolved in CDCl₃ (2 mL). An aliquot of 1,1,2,2-tetrachloroethane (50.0 μL) as internal standard was added and the solution was homogenized by swirling. The samples were analyzed by ¹H and ³¹P NMR spectroscopy. In the ¹H NMR, the amount of TCPP in the corresponding sample was determined by integration of the TCPP signal (δ=4.67 ppm) against the 1,1,2,2-tetrachloroethane signal (δ=6.00 ppm).

The reaction mixture of entry 2 was additionally purified by flash column chromatography (EtOAc-hexane) to determine the amount of amine. In the end, the silica pad was flushed with EtOH to elute the polyol fraction.

Table 2: Hydrogenation of PU rigid foam Index 100 (polyurethane rigid foam containing phosphorous ester flame retardants).

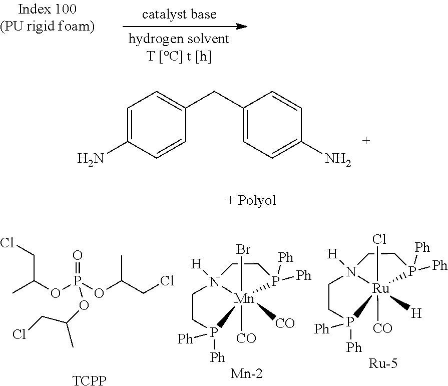

| | PU rigid foam | catalyst | base | H₂ pressure | organic solvent | T | t | conversion | flame ret. ^{[1]} | polyol | amine |
|---|---|---|---|---|---|---|---|---|---|---|---|
| # | [g] | [μmol] | [μmol] | [bar] | volume [mL] | [° C.] | [h] | [%] | [g] | [g] | [g] |
| 1 | 1 | Mn-2 | KOH | 50 | ⁱPrOH | 180 | 21 | 93 | — ^{[2]} | n.d. ^{[3]} | n.d. ^{[3]} |
| | | 2.1 | 21 | | 2.5 | | | | | | |
| 2 | 1 | Mn-2 | KOH | 50 | ⁱPrOH | 180 | 21 | >99 | 0.010 ^{[4, 5]} | 0.461 ^{[4, 6]} | 0.488 ^{[4, 7]} |
| | | 16.0 | 160 | | 19.2 | | | | | | |
| 3 | 1 | Ru-5 | KOH | 50 | ⁱPrOH | 180 | 21 | >99 | — ^{[2]} | n.d. ^{[3]} | n.d. ^{[3]} |
| | | 16.0 | 160 | | 19.2 | | | | | | |

^{[1]} flame retardant = TCPP
^{[2]} no flame retardant detected
^{[3]} not determined
^{[4]} quantification after flash column chromatography (EtOAc-hexane)
^{[5]} the isolated fraction contained decomposed flame retardant
^{[6]} contains aromatic side products as well as solvent (EtOH) according to ¹H NMR
^{[7]} contains solvent (EtOAc) as well as alkylated (mono or diisopropyl) amine

### LITERATURE CITED

U.S. Pat. No. 4,196,148A
WO2010/130652A2
DE2854940A1
CN107337615B
WO 2015/121057
WO 2013/139781
Ullmann's Encyclopedia of Industrial Chemistry, Phosphorus Compounds, Organic, 2012, DOI: 10.1002/14356007.a19_545.pub2
Chemosphere, 2012, 88, 1119-1153 and WO 2015/121057
Plastics recycling and Polyurethanes, in Ullmann's Encyclopedia of Industrial Chemistry, 2020, DOI: 10.1002/14356007.a21_057.pu
ChemSusChem, 2020, DOI: 10.1002/cssc.20200246 or ChemSusChem, 2021, DOI: 10.1002/cssc.202101705
T. Skrydstrup et al., JACS Au, 2021, DOI: 10.1021/jacsau. 1c0005
Zhurnal Obshchei Khimii, 1978, 78, 694-695
J. Chem. Eng. Data, 2008, 53, 2718-2720
T. Schaub et al., ChemSusChem, 2021, DOI: 10.1002/cssc.202101606
T. Skrydstrup et al., ChemSusChem, 2021, DOI: 10.1002/cssc.202101705

1. A value chain return process for polyurethane and polyisocyanurate rigid foams containing at least one additive (A1), which is not chemically bonded to a polymer chain of the foam, the additive (A1) being selected from the group consisting of a phosphorous ester-based flame retardant, a polymerization catalyst, and a surfactant, the process comprising:
a) providing a composition comprising a comminuted polyurethane or polyisocyanurate rigid foam, wherein the comminuted foam has a content of intact cells of less than 10%, based on a number of intact cells of the polyurethane or polyisocyanurate rigid foam when not comminuted; and
b) extracting the additive (A1) with a solvent at a temperature below 190° C.

2. The process according to claim 1, further comprising:
c) depolymerizing the comminuted polyurethane or polyisocyanurate obtained in b).

3. The process according claim 2, wherein depolymerizing is carried out by a method selected from the group consisting of hydrolysis, glycolysis, hydrogenation, and aminolysis.

4. The process according claim 3, wherein depolymerizing is carried out by hydrolysis in the presence of at least one selected from the group consisting of a catalytic active component, an ionic liquid, a phase transfer catalyst, and a base.

5. The process according claim 4, further comprising:
d) the separating an isocyanate component or amine derivative thereof and a polyol component.

6. The process according claim 3, wherein depolymerizing is carried out by glycolysis in the presence of a metal catalyst.

7. The process according claim 3, wherein depolymerizing is carried out by hydrogenation in the presence of hydrogenation catalyst.

8. The process according to claim 1, wherein the polyurethane rigid foam is claim 1 an aromatic isocyanate-based polyurethane rigid foam.

9. The process according to claim 1, wherein the additive (A1) is at least one phosphorous ester-based flame retardant is selected from the group consisting of tris(2-chloroethyl)phosphate, tris(chloroisopropyl)phosphate, tris(1,3-dichloro-2-propyl)phosphate, tris(2-ethylhexyl)phosphate, tricresylphosphate, tris-(2,3-dibromo)phosphate, tetrakis-(2-chlorethyl)-ethylenediphosphate, dimethylphosphonate, dimethylpropylphosphonate, diphenylcresylphosphate, and triethylphosphate.

10. The process according to claim 1, wherein the additive (A1) is a tertiary amine polymerization catalyst.

11. The process according to claim 1, wherein the additive (A1) is a silicone-based cell stabilizer.

12. The process according to claim 1, wherein the solvent is selected from the group consisting of an organic aprotic solvent, water, a polyol, and an alcohol.

13. The process according to claim 12, wherein the solvent is at least one organic aprotic solvent is selected from the group consisting of an aliphatic hydrocarbon, a halogenated hydrocarbon, an ether, an aromatic hydrocarbon, an ester, and a ketone.

14. The process according to claim 1, wherein extracting is carried out at a temperature of 20 to 190° C.

15. A polyol composition obtained by the process of claim 1.

16. A method for preparation of a polyurethane or polyisocyanurate comprising employing a phosphorous ester-based flame retardant obtained by the process of claim 1.

17. A method for preparation of a polyurethane or polyisocyanurate comprising employing a polymerization catalyst obtained by the process of claim 1.

18. A method for preparation of a polyurethane or polyisocyanurate comprising employing a stabilizer obtained by the process of claim 1.

19. A method for preparation of a polyurethane or polyisocyanurate comprising employing the polyol composition according to claim 15.
